(19) United States
(12) Patent Application Publication
(10) Pub. No.: US 2020/0155400 A1
(43) Pub. Date: May 21, 2020

(54) PATIENT HANDLING APPARATUS AND METHOD

(71) Applicant: DAVID E.T. GARMAN CONCEPTS LIMITED, Preston, Lancashire (GB)

(72) Inventors: Austin William OWENS, Leominster, Herefordshire (GB); David Edmund Talbot GARMAN, Llandrindod Wells, Powys (GB)

(21) Appl. No.: 16/609,390

(22) PCT Filed: Apr. 26, 2018
(86) PCT No.: PCT/GB2018/051100

§ 371 Date: Oct. 29, 2019

(30) Foreign Application Priority Data
May 2, 2017 (GB) 1706956.8

(51) Int. Cl. A61G 7/16; A61G 7/10; A61G 7/057

(52) U.S. Cl. CPC A61G 7/165; A61G 2200/34; A61G 7/05776; A61G 7/1021

(57) ABSTRACT

A patient handling apparatus includes an inflatable patient cradle (10″) for holding and supporting a patient in a sitting position when inflated and an air compressor (90) connectable to the cradle to inflate the cradle. The air compressor (90) has a control system for regulating the pressure of inflation of the cradle (10″) in use and is operative in a high pressure mode to bring the cradle to a first pre-defined inflation pressure for use in transferring a patient and operable in a reduced pressure mode to bring at least part of the cradle to a second pre-defined inflation pressure lower than the first pre-defined inflation pressure. In the lower pressure mode, the cradle (10″) is more comfortable to sit on for prolonged periods whilst still providing adequate support to hold a patient upright.

### TECHNICAL FIELD OF THE INVENTION

The present invention relates to patient handling. The invention relates in particular to apparatus and methods for moving and supporting a patient and especially, but not exclusively, to apparatus and methods for transferring and supporting a disabled, elderly and/or otherwise infirm person.

### BACKGROUND TO THE INVENTION

People who are severely ill, elderly, disabled or otherwise infirm may lose the ability to move freely on their own and require assistance for repositioning and movement. This is a particular issue for people who have insufficient upper body strength to support themselves in an upright sitting position without assistance and for people who are very heavy, such as bariatric patients. The responsibility for assisting such people falls to care providers who reposition patients to prevent pressure ulcers and promote comfort and who transfer patients between supporting structures, such as between beds, chairs, wheelchairs or patient trolleys for example. In some situations, a person must be transferred vertically, say between equipment with support surfaces of different heights. In other cases, the transfer is predominantly in a lateral or otherwise generally horizontal direction. This might be the case where a patient is repositioned on a bed or is transferred between adjacent surfaces at the same height, such as between a bed and an adjacent patient trolley, or between a chair and a commode, for example.

Research has shown that care providers experience significant physical stress when performing manual lifting and repositioning tasks which can lead to physical injury, including musculoskeletal disorders that can cause chronic back pain. Manual handling is also undesirable for the patient who is at risk of pain and discomfort, skin tears, bruising and being dropped, as well as suffering indignity. One of the highest risk manual handling activities is transferring a patient on or off a bed. This often requires the care provider to reach across the bed adopting a bad posture which can result in high physical stress to their body, particularly their back. The relatively soft nature of bed mattresses adds to the difficulty as they tend to compress when a force is applied, making it more difficult to move a patient safely and efficiently.

To alleviate the problems outlined above, various apparatus and methods have been developed over the years. Technologies to assist with vertical transfer of patients include powered full-body sling lifts, floor-based lifts, ceiling-mounted lifts, powered standing lifts, non-powered standing aids and gait/transfer belts. Technologies to assist with horizontal/lateral transfer and repositioning of patients include air-assisted systems, friction-reducing devices such as glide sheets, mechanical lateral transfer aids, sliding boards and transfer chairs.

Many of the apparatus discussed above have significant drawbacks. Glide sheets are easily positionable beneath a patient lying on a surface using the so-called “log roll” technique in which the patient is first rolled over to one side and then to the other to enable the sheet to be maneuvered into position. However, they offer little support to the patient who may feel vulnerable during transfer. For patients who are unable to sit-up unaided, glide sheets are generally used with the patient lying supine and so are of limited use in transferring such a patient where they must be moved between lying and sitting positions, Whilst glide sheets reduce friction between the patient and the surface on which they are lying or sitting, they still often require significant force to be applied to manually move the patient. Transfer boards are useful for transferring a patient in a sitting position but are of limited use for patients who have insufficient upper body strength to support themselves unaided in an upright sitting position.

Other types of apparatus require the patient to be manually lifted when positioning them on the equipment. This can be especially problematic when the patient is on a bed due to the soft nature of the bed mattress and the difficulty in reaching a patient positioned centrally in bed.

Powered lifting aids such as lifts and hoists are often expensive, heavy and bulky. Ceiling-mounted lifts operate on a fixed run and so do not offer flexibility of use. Mobile hoists tend to be large and difficult to manoeuvre and so are not always able to be used where access is limited. Storage of mobile hoists can also be problematic. Hoists and lifts are used with slings which must be carefully selected to suit the particular patient and also regularly cleaned and disinfected, often rendering them weaker, or disposed of altogether. A further issue with powered lifting aids is that they require significant training to use safely and competently.

To overcome many of the problems associated with the methods and apparatus for transferring people discussed above, we have proposed an inflatable patient support cradle in UK patent GB2529954B, which was granted on 6 Dec. 2016. The cradle comprises a number of inflatable panels which define a seating area, a back and shoulder support, and side panels. The uninflated panels are relatively thin and flexible so that they can be easily positioned beneath a patient lying on a bed with a minimum of manual handling, using techniques similar to those used for positioning a glide sheet. However, once inflated the cradle defines a rigid structure capable of supporting and holding a patient in an upright sitting position, including patients who have little or no upper body strength. With a patient supported in the inflated cradle, the cradle can be easily moved across a surface or between one surface and another. The cradle can be used together with ancillary equipment, such as a mobile transfer unit, to form a safe, versatile and yet easy to use patient handling system. Because the patient is stably supported in the cradle whilst it is moved, the patient is less prone to injury during transfer and the experience is relatively comfortable and secure. The cradle is inflated to a high pressure, typically at least 27 kPa, in order to ensure that the patient is adequately supported for transfer. Inflating the cradle to a high pressure so that the panels are rigid also makes it easier for the cradle to be moved over a surface, especially a relatively soft surface such as that of a mattress.

Whilst the patient transfer cradle is very effective, there is still a need for a patient transfer apparatus and method which offers greater flexibility in its uses and applications.

### SUMMARY OF THE INVENTION

In accordance with a first aspect of the invention, there is provided patient handling apparatus comprising an inflatable patient cradle for holding and supporting a patient in a sitting position when inflated, and an air compressor connectable to the cradle to inflate the cradle, the air compressor having a control system for regulating the pressure of inflation of the cradle in use, wherein the control system is operative in a high pressure mode to bring the cradle to a first pre-defined inflation pressure and operable in a reduced pressure mode to bring at least part of the cradle to a second predefined inflation pressure lower than the first pre-defined inflation pressure.

The control system may comprise a pressure sensor arrangement for detecting the pressure of air in the cradle, or at least the pressure of the air in said at least a part of the cradle, and a user input for selectively activating the reduced pressure mode of operation. The control system may be configured to automatically bring said at least a part of the air cradle to the second pre-defined inflation pressure when the reduce pressure mode is activated. The control system may include a microprocessor programmed to regulate the pressure of said at least a part of the cradle in dependence on an input from the pressure sensor arrangement indicative of the pressure of the air in said at least a part of the cradle.

The inflated cradle may be capable of holding and supporting a patient in an upright sitting position when inflated to each of the first and the second pre-defined inflation pressures. Accordingly, the second pre-defined pressure may be selected such that the cradle remains capable of holding and supporting a patient in a sitting position when inflated to the second pre-defined inflation pressure. The apparatus may be configured such that, in use, the shape of the inflated cradle is substantially the same when inflated to either of the first and second pre-defined pressures but the firmness said at least a part of the cradle is lower when inflated to the second pre-defined than when inflated to the first pre-defined pressure.

The air compressor may be an electric air compressor having a pump.

In an embodiment, the cradle comprises a plurality of inflatable sections, each inflatable section comprising a soft-walled inflatable body which is flexible when un-inflated. All the inflatable sections may be fluidly interconnected when the cradle is assembled so as to be inflatable simultaneously by the compressor, the compressor being operative in use to regulate the pressure in the cradle as a whole. Alternatively, at least some of the inflatable sections of the cradle are inflatable independently of each other, and the air compressor may be operative in use to regulate the pressure in at least some independently inflatable sections independently of one another.

The cradle may comprise an inflatable seat section, an inflatable back-support section and a pair of opposed side panel sections, each side panel section extending between and connected with the seat section and the back support section, at least when the cradle is assembled and inflated. The side panel sections may be inflatable.

The air compressor may be operative in use to introduce pressurised air into the cradle and to allow air out of the air cradle to regulate the inflation pressure under control of the control system.

The air compressor may be operative in use when connected to the cradle to monitor the inflation pressure of the cradle and to maintain the inflation pressure substantially at the respective pre-defined pressure within limits.

In an embodiment, the compressor has a pump having an outlet fluidly connectable with the cradle via at least one fluid supply line, the control system including a pressure sensor for sensing the pressure of air in the fluid supply line. The control system may also comprise a solenoid operated dump valve fluidly connected with the fluid supply line and operable to allow air to vent from the fluid supply line. The control system may further include a microprocessor operative to regulate the inflation pressure of the cradle by controlling operation of the pump and the dump valve in dependence on a signal from the pressure sensor.

The compressor may have at least two fluid supply lines, the control system having a respective pressure sensor and a dump valve associated with each fluid supply line, the microprocessor being configured to regulate the inflation pressure of inflatable sections of the cradle connected with each fluid supply line independently of one another.

The first pre-defined inflation pressure may be at least 27 kPa.

The second pre-defined inflation pressure may be in the range of 6 kPa to 20 kPa lower than the first pre-defined inflation pressure. The second pre-defined inflation pressure may be in the range of 7 kPa to 21 kPa.

The control system may be operative in the reduced pressure mode to alternately vary the inflation pressure of said at least a part of the cradle within set limits, wherein the maximum inflation pressure is the second pre-defined pressure lower than the first pre-defined inflation pressure.

In an embodiment, at least the inflatable seat section of the cradle comprises a first set of inflatable cells and a second set of inflatable cells, the cells of the first and second sets being alternately located, the system configured such that in use when the compressor is in the reduced pressure mode it is selectively operable to alternately inflate and deflate the first and second sets of cells. The fluid circuit may include at least one fluid accumulator in fluid connection at least one set of cells for storing pressurised air released from said at least one set of cells when they are deflated and the system may be configured such that in use, pressurised air stored in the at least one accumulator can be used to re-inflate at least one set of cells.

In accordance with a second aspect of the invention, there is provided a method of handling a patient using apparatus in accordance with the first aspect of the invention, the method comprising:

with the patient supported in the cradle inflated to the first pre-defined pressure and the compressor connected to the cradle, using the compressor to reduce the pressure of at least part of the cradle to the second pre-defined pressure by placing the compressor in the reduced pressure mode.

The method may be such that the firmness of said at least a part of the cradle is reduced without substantially altering its shape when it is brought to the second pre-defined pressure.

The method may comprise using the compressor to maintain the inflation pressure of said at least a part of the cradle at the second pre-defined pressure within pre-set limits.

The method may comprise subsequently using the compressor to inflate the cradle back to the first pre-defined inflation pressure by placing the compressor back into the high pressure mode.

Where at least the seat section includes a first set and a second set of cells, the method may comprise using the compressor to alternately inflate and deflate the first and second sets of cells. The method may comprise storing at least some of the pressurised air released from a set of cells when they are deflated in an accumulator and subsequently using the pressurised air stored in the accumulator to at least partially inflate a set of cells.

For the avoidance of doubt, it should be understood that the term “patient” is used herein in a general context to refer to any person who requires assistance in moving and it should be recognised that the patient handling system and methods as described and claimed are not limited to use in a hospital or other formal medical or care facility and could be equally used in a person's private home or indeed any other setting.

### DETAILED DESCRIPTION OF THE INVENTION

Several embodiments of the invention will now be described, by way of example only, with reference to the accompanying drawings, in which:

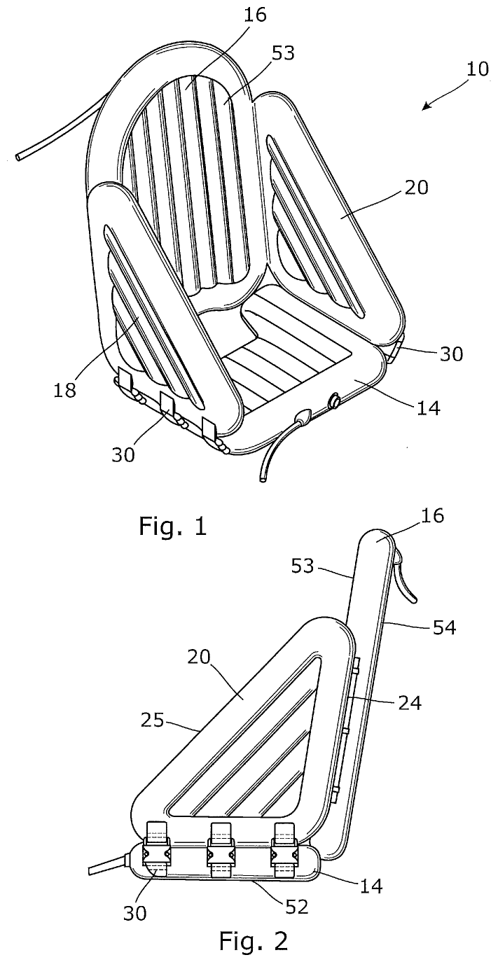

FIG. 1 is a perspective view showing a first embodiment of an inflatable patient cradle forming part of apparatus for handling a patient in accordance with an aspect of the present invention, showing the cradle inflated;

FIG. 2 is a view from the side of the cradle of FIG. 1;

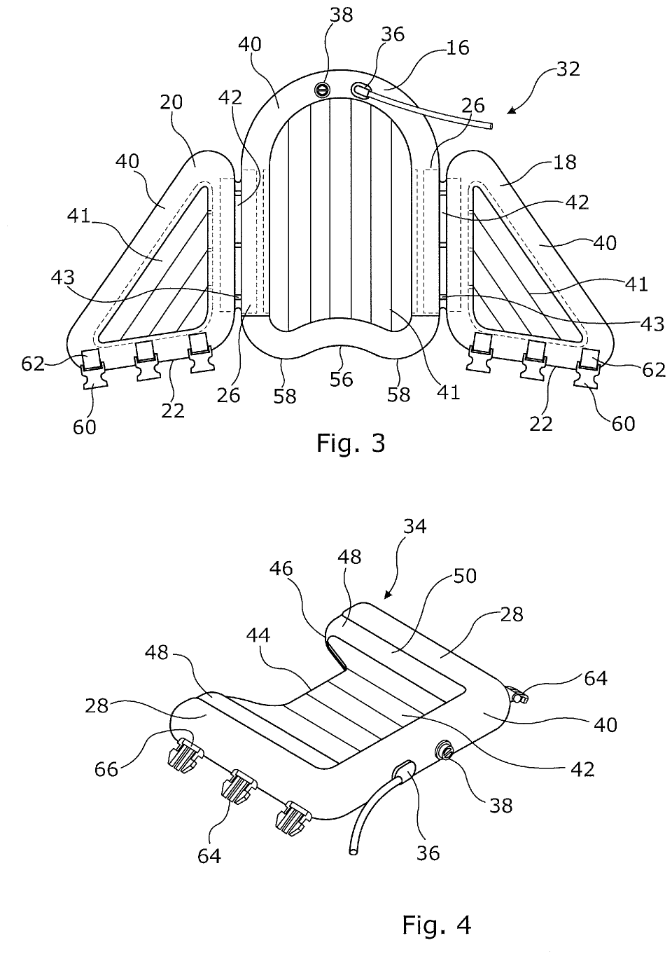

FIG. 3 is a view from the rear of a back-support section and integral side panel sections forming a first part of the cradle of FIG. 1;

FIG. 4 is a perspective view of a seat section forming a second part of the cradle of FIG. 1;

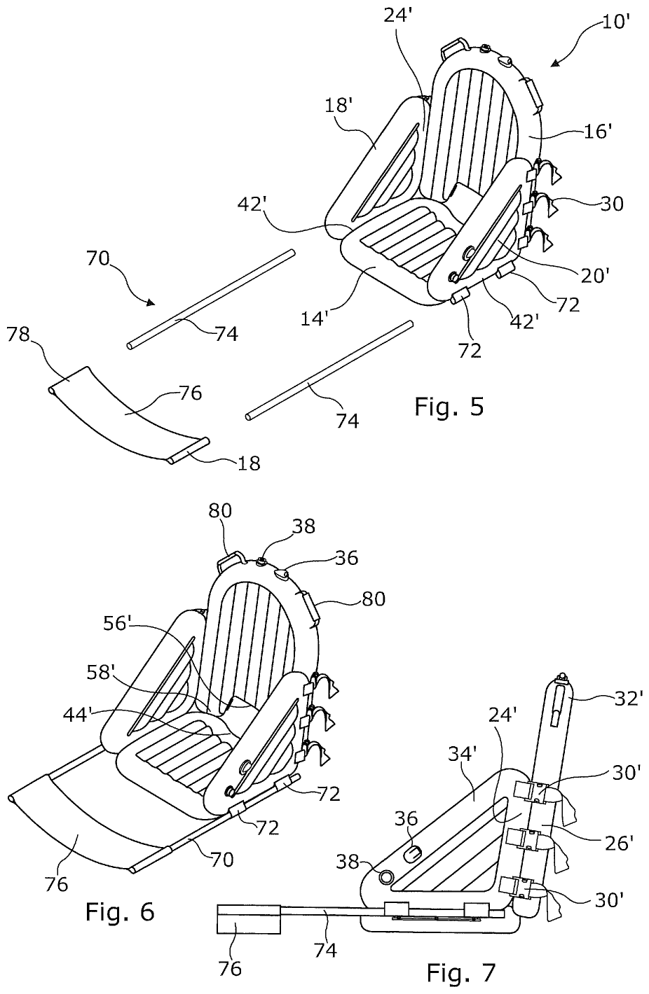

FIG. 5 is a perspective view of a second embodiment of an inflatable patient cradle forming part of apparatus for handling a patient in accordance with an aspect of the present invention but also showing elements of an associated lower leg support shown in exploded view;

FIG. 6 is a view similar to that of FIG. 5 but showing the lower leg support mounted to the cradle;

FIG. 7 is a view from the side of the cradle of FIG. 6;

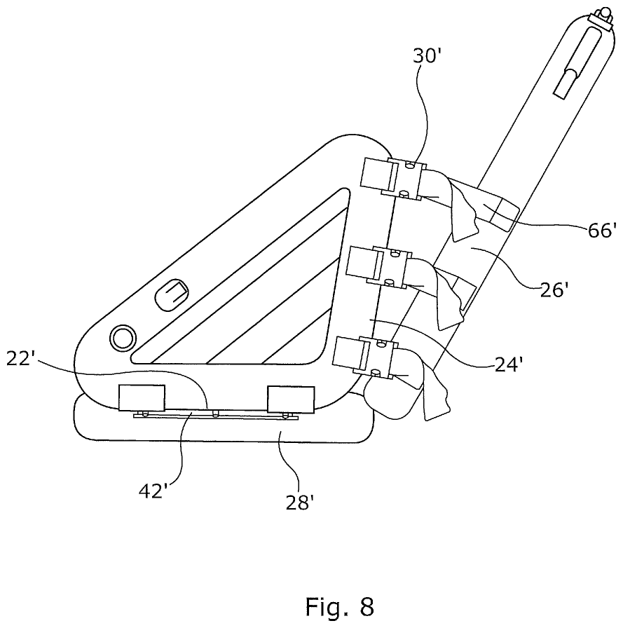

FIG. 8 is a view from the side of the cradle of FIG. 6 but with the lower leg support omitted and showing a back-support section in a semi-reclined position;

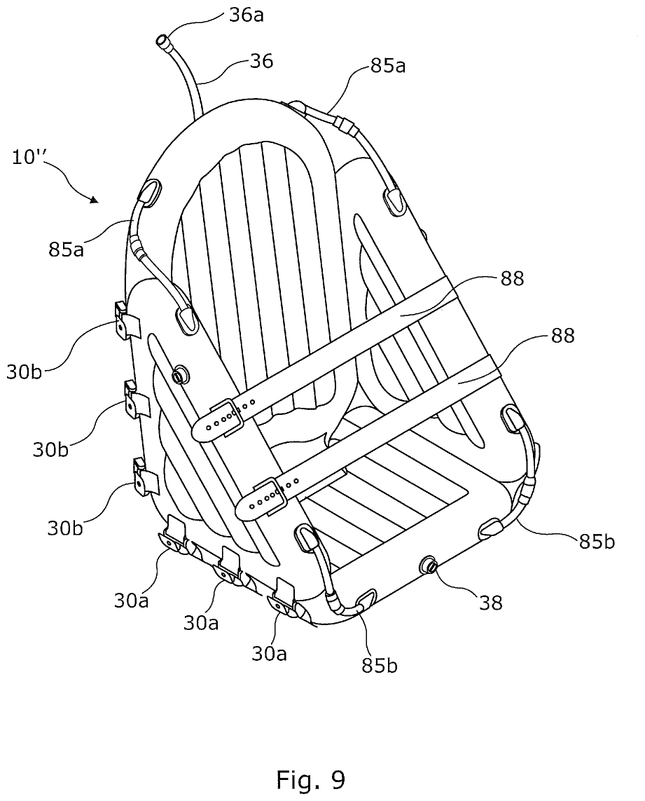

FIG. 9 is a perspective view of a third embodiment of an inflatable patient cradle forming part of apparatus for handling a patient in accordance with an aspect of the present invention, showing the cradle in an assembled and inflated configuration;

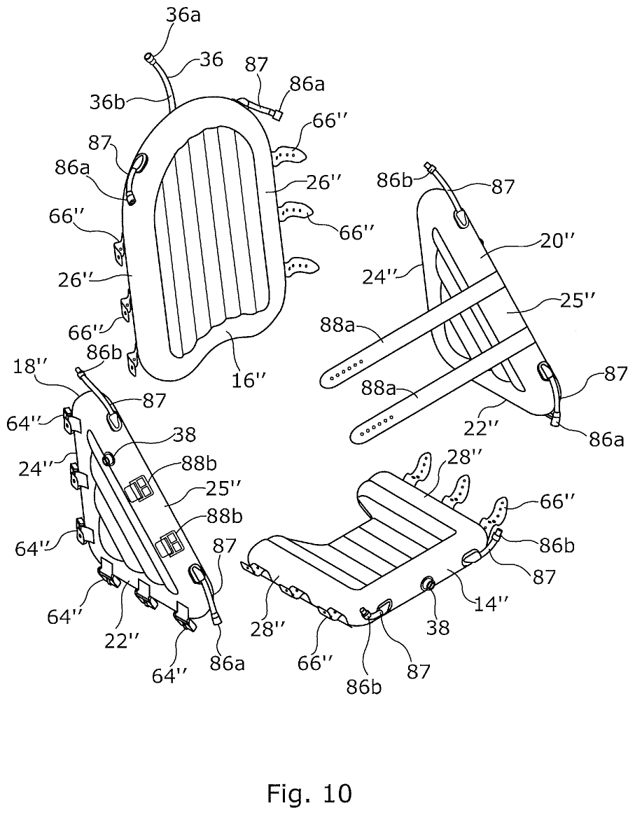

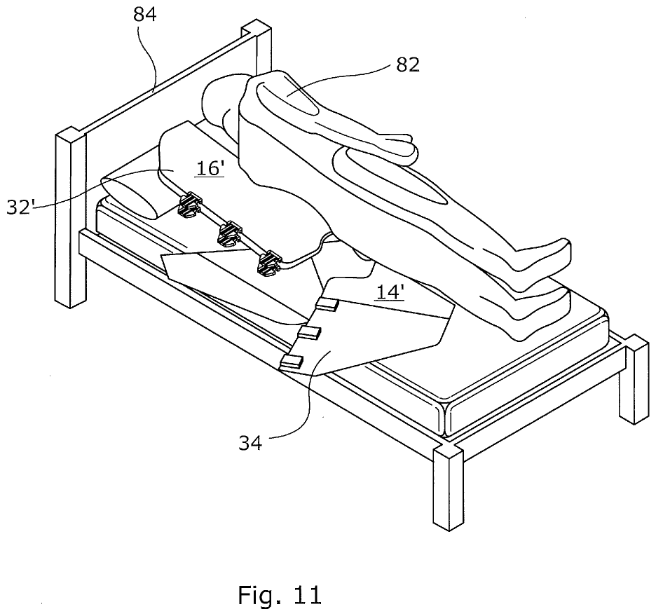

FIG. 10 is an exploded view of the cradle of FIG. 9;

FIGS. 11 to 17 are a series of perspective views illustrating fitting of the cradle of FIGS. 5 to 8 about a patient lying on a bed, subsequent inflation of the cradle and positioning the patient in an upright sitting position supported in the inflated cradle;

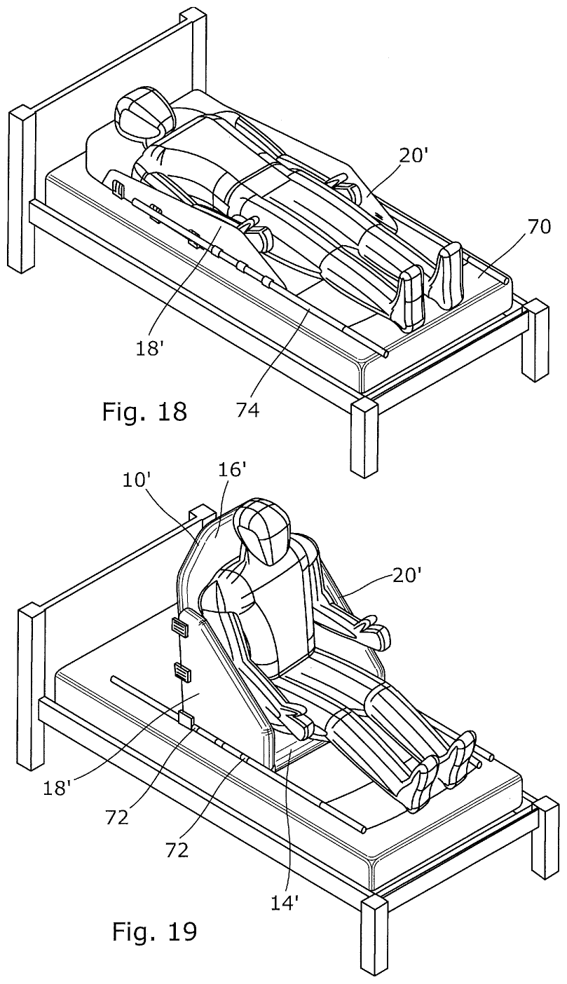

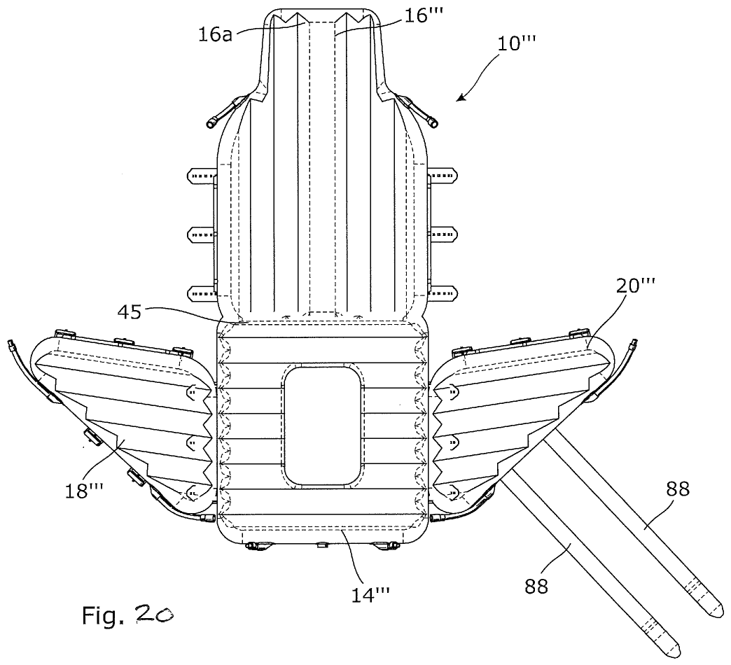

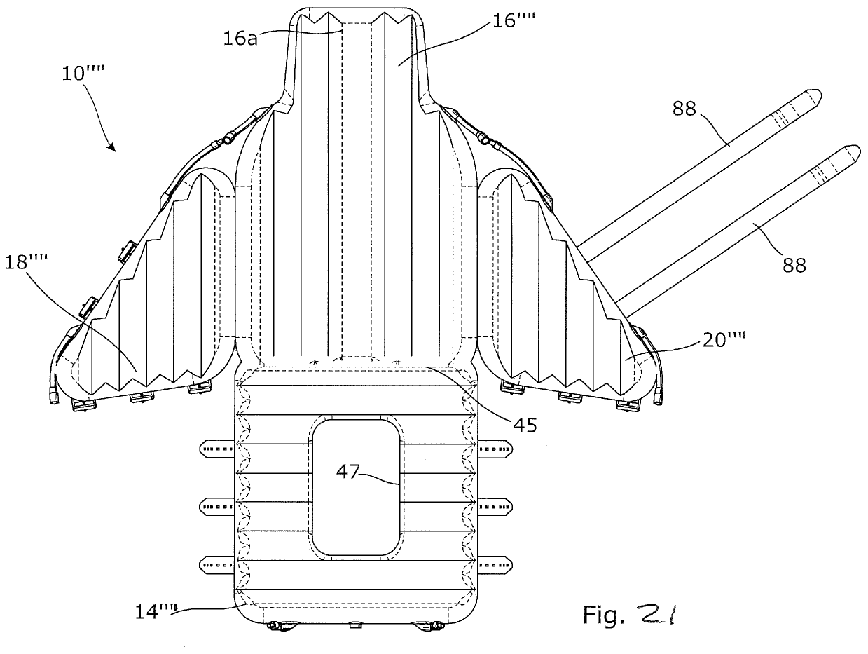

FIGS. 18 and 19 illustrate an alternative method of inflating the cradle of FIGS. 5 to 8 using a lower leg support to automatically place the patient in an upright sitting position as the cradle inflates;

FIGS. 20 and 21 are views from above of two further embodiments of an inflatable patient cradle forming part of apparatus for handling a patient in accordance with an aspect of the present invention, showing the cradle in an unassembled configuration for positioning about a patient;

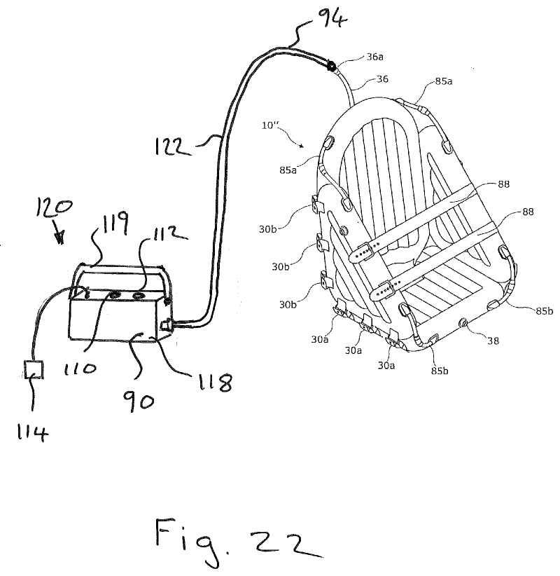

FIG. 22 is a perspective view of an embodiment of apparatus for handling a patient in accordance with an aspect of the present invention including a cradle as shown in FIG. 9 and a compressor;

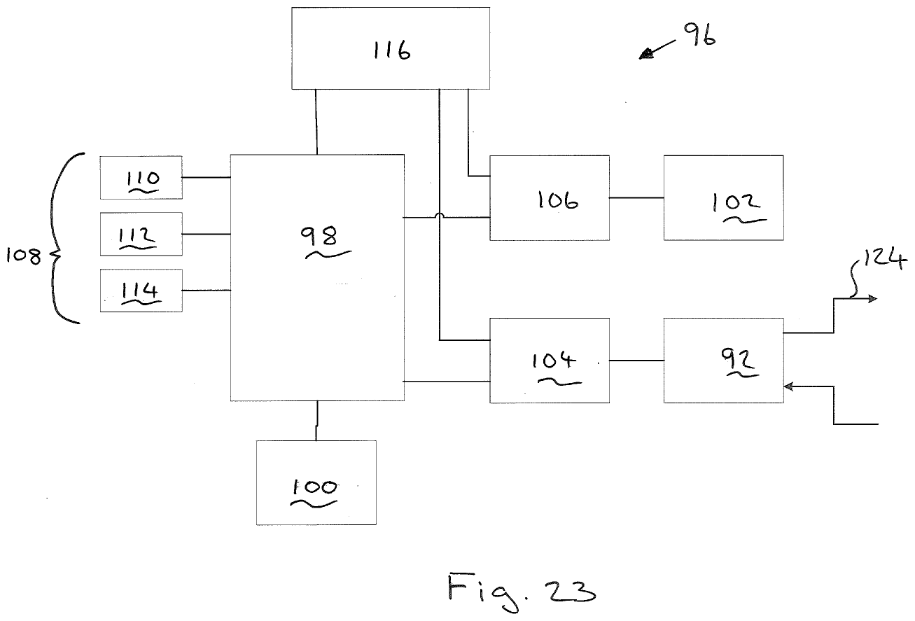

FIG. 23 is a schematic illustration of the components of the compressor in FIG. 22;

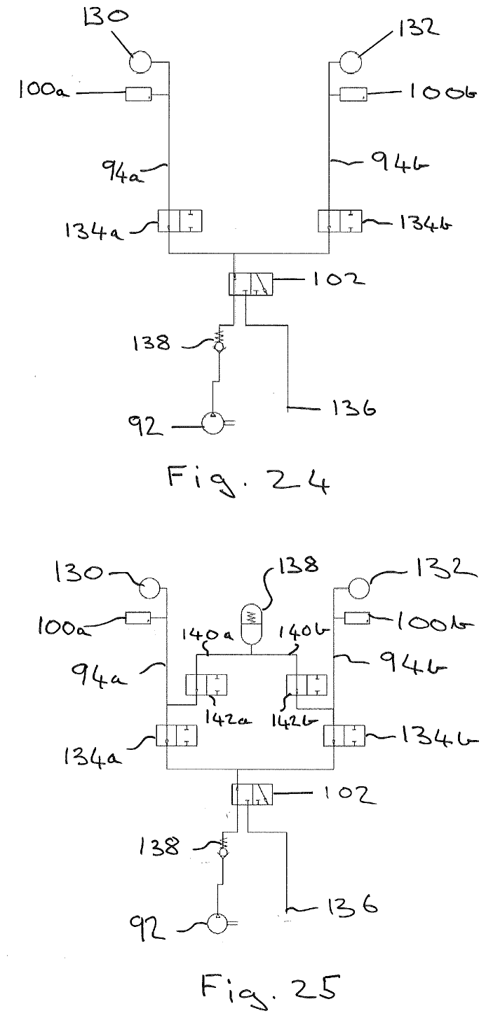

FIG. 24 is a schematic diagram of part of a fluid circuit for use in apparatus for handling a patient handling system in accordance with an aspect of the invention; and

FIG. 25 is a schematic diagram of part of a modified fluid circuit for use in apparatus for handling a patient handling system in accordance with an aspect of the invention.

FIGS. 1 to 4 illustrate a first embodiment of an inflatable patient transfer cradle 10. The cradle 10 is inflated using an air compressor 90 which will be described in detail below with reference to FIGS. 22 and 23. Together, the cradle 10 and the compressor 90 form a patient handling apparatus in accordance with an aspect of the invention.

The cradle 10 is a pneumatically-inflatable device configured to be positioned in an un-inflated condition about a patient located on a surface and inflated to raise them off the surface using the air compressor 90. Once fully inflated, the cradle 10 forms a generally rigid, self-supporting seat structure in which the patient is stably and comfortably held in an upright sitting position for transfer in the cradle between different locations. The cradle 10 can be used, for example, to reposition a patient on a support surface but can also be used to transfer a patient from one supporting structure to another, such as between a bed and a chair.

The cradle 10 has a seat section 14, a back-support section 16 and opposed side panel sections 18, 20, each section being a soft-walled pneumatically-inflatable structure. In an upright condition when the cradle is inflated, as illustrated in FIGS. 1 to 4, the seat section is located generally horizontally on a supporting surface and the back-support section 16 extends upwardly from a rear edge of the seat section 14. The side panel sections 18, 20 are located on opposite sides and extend forwardly between the back-support section 16 and seat section 14 to which they are connected. The back-support section 16 may be slightly reclined rather than vertical for patient comfort.

In the assembled and inflated cradle, the side panel sections 18, 20 are each connected with seat section 14 and the back-support section 16 and are operative to hold the back-support section 16 in position extending generally upwardly from the seat section 14 in a self-supporting manner when a patient is sitting in the cradle with their back resting on the back-support section. Accordingly, the term “self-supporting seat structure” is used to refer to a structure which is capable of independently supporting a patient in an upright sitting position when the seat section 14 is located on a supporting surface without any external support to hold the back-support section 16 extending upwardly. Thus with the weight of the patient sitting on the seat section 14 to holding the seat section 14 down on the surface, the side panel sections 18, 20 act in tension to hold the back-support section generally upright and thus support the patient's back.

Relative directional terms such as “upper” and “lower”, “forward” and “rearward” and the like used in relation to the cradle or parts thereof refer to the cradle when in the upright inflated configuration as shown in FIG. 1 and should be understood accordingly. However, it will be appreciated that the cradle can be used in other orientations.

The term “upright sitting position” as used herein in relation to a patient supported in the inflated cradle refers to a position in which the patient's buttock region is supported on the seat section 14 when the seat section is generally horizontal, with their torso generally upright so that their upper legs extend at an angle to their upper body. Typically the patient's upper legs will extend at an angle to their torso in the range of 80 to 140 degrees, or more particularly 85 to 120 degrees. The term “upright” does not require that the patient's back be aligned vertically but should be understood more generally as encompassing the patient's back being reclined by anything up to 45 degrees. The term “sitting position” as used herein in relation to a patient supported in the inflated cradle refers to a position which is similar to that of an upright sitting position as defined above but covers the situation where the seat section is not horizontal. The term “sitting position” thus covers the situation where the patient is supported in the inflated cradle but with the back-support section horizontal on a supporting surface and the seat section extending upwardly from the support surface.

The term “supine position” as used herein in relation to a patient refers to a position in which the patient is lying on their back with their legs extending out in front of them on a surface on which they are lying. In this position, the patient's legs will be generally flat so that their upper thighs are in-line with their back. It will be appreciated that in practice the patient's thighs may be angled slightly, though not to the same extent as when the patient is in a sitting position.

When viewed in elevation from a side of the inflated cradle, each of the side panel sections 18, 20 is generally triangular in shape having a lower horizontal edge 22, a rear edge 24 which extends generally upwardly from the lower edge, and an angled forward edge 25 which extends from a forward end of the lower edge 22 to the upper end of the rear edge 24. The side panel sections 18, 20 are each connected along their rear edge 24 with a respective side edge region 26 of the back-support section 16 and along the lower edge 22 with the corresponding side edge region 28 of the seat section 14. Whilst a triangular shape has been found to be particularly advantageous for the side panel sections, it will be appreciated that the shape of the side panel sections can be varied.

The cradle 10 in this embodiment is formed in two separable parts 32, 34 connected together by means of releasable fasteners 30. The parts can be separated and positioned about a patient when un-inflated and subsequently connected together before being inflated. Each part is independently inflatable, though in practice both parts are typically inflated at the same time. In this embodiment, the side panel sections 18, 20 are constructed integrally with the back-support section 16 to form a first part 32 of the cradle and the seat section 14 is a separate component which forms a second part 34. In this arrangement, the lower edge regions 22 of the side panel sections are releasably attached to the sides 28 of the seat section 14 by means of the releasable fasteners 30. Each part 32, 34 of the cradle is a separately inflatable soft-walled body having a one-way inlet valve 36 through which air under pressure can be introduced to inflate the body from the compressor 90 and a release or dump valve 38 which can be selectively opened to allow air to escape to deflate the body.

Each of the two parts 32, 34 of the cradle are made from thin sheet material which is tough but very flexible and is impervious to air. The parts may be made of fabric material suitably treated to make it impervious to air, such as a polyurethane-coated nylon fabric for example. The material is formed into a bag-like structure or bladder for holding a volume of pressurised air (that is to say air at a pressure above the ambient air pressure). When un-inflated, each part 32, 34 is relatively thin and highly flexible and so is easily positionable beneath and/or about the patient when they are laid or sitting on a bed, chair or other similar supporting structure, for example in a manner similar to that used to position a glide sheet. Indeed, when un-inflated each part 32, 34 has a thickness substantially equal to twice the thickness of the sheet material from which it is made and has a flexible, fabric-like structure. Each part 32, 34 has opposed walls which define the major surfaces of the part when inflated. The opposed walls are interconnected by a series of internal webs and/or welds which limit their separation as the part is inflated in order to give a desired profile when inflated. The parts are profiled in this way so that each inflatable section 14, 16, 18, 20 defines a generally cylindrical outer frame portion 40 and a fluted region 41 within the outer frame to give the sections structural stability when inflated. In addition, the opposed walls in the first part 32 are welded together to define a hinge portion 42 between the back-support section 16 and each side panel section 18, 20. Fluid passages 43 are defined through the hinge portions 42 so that the back-support section 16 and the two side panel sections are fluidly interconnected to enable them to be inflated from a single inlet valve 36 and deflated through a single dump valve 38. However, each side panel section 18, 20 could alternatively be fluidly connected with the back-support section 16 by means of an external fluid connection having a coupling incorporating a non-return valve and in which parts of the coupling are connected to their respective section by a flexible hose.

The seat section 14 is in the form of an inflatable cushion for positioning under the thighs and buttock region of the patient. It has a generally rectangular profile in plan when viewed from above but with a recessed region or indent 44 centrally located along the rear edge 46 between a pair of rearwardly projecting shoulders 48. The opposed walls which define the major surfaces of the seat section are an inner or upper wall 50 on which the patient sits and an outer or lower wall 52 for positioning on a support surface when the cradle is positioned upright. The cylindrical outer frame portion 40 extends along either side and across the front of the seat section. When inflated, the fluted region 41 has a depth in the region of 3 cm to 10 cm so that a person seated on it can be stably supported with their buttocks and upper thighs raised off a support surface on which the lower wall 52 of seat section 14 is positioned.

In the first part 32 of the cradle, the opposed walls which define the major surfaces are an inner wall 53 which is directed towards the patient in use and an outer wall 54 which is directed away from the patient. The back-support section 16 and each of the side panel sections 18, 20 define an internal volume for containing a quantity of pressurised air so that they each form a substantially rigid, panel-like structure when inflated. The side panel sections 18, 20 are pivotally connected to the back-support section 16 along the hinge portions 42 where the inner and outer walls are welded together so that when the second part is inflated, the rigid side panel sections 18, 20 can extend forwardly, substantially perpendicular to the back-support section 16. The back-support section 16 and the side panel sections 18, 20 may each have a thickness in the region of 3 cm to 10 cm when fully inflated.

The lower edge of the back-support section 16 has a central concave recess 56 between a pair of downwardly projecting shoulders 58 on either side. The central recess 56 aligns with the recessed region 44 along the rear edge of the seat section 14. These two recessed regions 44, 56 allow the seat section 14 and the back-support section 16 to be positioned about a person in an un-inflated condition whilst the person remains seated or lying on a surface without having to lift them fully off the surface, as will be described in detail later. This is particularly advantageous when positioning the cradle 10 about a person sitting upright on a chair where access to the patient from the side may be limited.

The cradle 10 is configured so that the seat section 14 is received in the space defined between the back-support section 16 and the two side panel sections 18, 20, when all the sections are inflated and the side panel sections 18, 20 are positioned to extend forwardly from the back-support section 16. A plurality of releasable fasteners 30 is provided to connect the lower edge region 22 of each of the side panel sections 18, 20 to a respective side edge region 28 of the seat section. In the present embodiment, three fasteners 30 are provided on each side and the fasteners are quick-release buckle type fasteners, each comprising a female buckle member 60 attached by means of a flexible strap 62 to an outer, lower edge region 22 of the respective side panel portion 18, 20 and a corresponding male buckle member 64 attached by a flexible strap or other fastening 66 to a respective side edge region 22 of the seat section 14. The buckle type fasteners 30 may be in the form of quick-release spring clips similar to those used on rucksacks in which the female buckle member 60 has a pair of resilient arms which are squeezed together for insertion into the male buckle member 64 and which after insertion spring out to engage with locking detents on the male buckle member 64 to prevent the female buckle member being pulled back out of the male member without first squeezing the resilient arms together. Apertures in the male buckle member 64 allow a user to squeeze the resilient arms inwardly to release the female buckle member. At least one of the straps 62, 66 may be adjustable in length to allow the angle of the back-support section 16 to be adjusted relative to the seat section 14 once the cradle has been inflated.

The releasable fasteners 30 transit forces in tension between the seat section 14 and the respective side panel section 18, 20 to hold the back-support section 16 upright through the side panel sections 18, 20 when the cradle is inflated. The fasteners 30 must be capable of transmitting sufficient force that the back-support section 16 is held upright when a patient is sitting in the inflated cradle with their upper torso resting on the back-support section 16 without the aid of any external support for the back-support section. This enables the cradle 10 to independently hold a patient in an upright sitting position when the cradle is positioned upright but where there is no external support against which the back-support section 16 of the cradle can be positioned, such as when the cradle is in the middle of a bed or when being moved between supporting surfaces, the forces that must be transmitted will depend on the size and weight of the patient but can be significant for use with bariatric patients.

The positions of the male and female buckle members 60, 64 could be reversed. Indeed, it should be appreciated that releasable fasteners 30 of any suitable type can be used to connect the seat section 14 and side panel sections 18, 20 subject to the requirements discussed above. These might include, for example, toggle fasteners, hook and loop fasteners, or strap and buckle type fasteners such as those described in relation to a third embodiment of the cradle described below.

It will be noted that all the major structural parts of the cradle which support the patient are soft-walled inflatable structures. Only the fitments, such as the buckles and fluid inlets/outlets, are made of rigid materials. This makes it easier to place the cradle about a patient when un-inflated.

FIGS. 5 to 8 illustrate an alternative embodiment of a patient cradle 10′ also in accordance with the first aspect of the invention. The cradle 10′ is similar to the cradle 10 according to the first embodiment as described above to which the reader should refer and so only the significant differences will be described in detail.

The main difference between the cradle 10′ in accordance with the second embodiment and the first embodiment is that the side panel sections 18′, 20′ are integral with the seat section 14 to comprise the second part 34′ of the cradle, with the back-support section 16 on its own forming the first part 32′. The parts 32′, 34′ are manufactured in a similar manner to those of the first embodiment from a flexible membrane or fabric-like material formed into a bag-like or bladder structure for holding a volume of pressurised air with the opposed walls interconnected by a series of internal webs and/or welds in order to give a desired profile and depth when inflated. In this embodiment, the opposed walls in the second part 34′ are welded together to define a hinge portion 42′ between the side edges 28′ of the seat section 14′ and the lower edge region 22′ of each side panel section 18′, 20′.

The side panel sections 18′, 20′ are releasably connectable along their rear edge regions 24′ to respective side edge regions 26′ of the back-support section 16′ by means of a plurality of releasable fasteners 30′, similar to those used in the first embodiment to attach the side panel sections to the seat section as described above. FIG. 8 illustrates how the straps 66′ connecting buckle members to the sides of the back-support section 16′ can be lengthened to allow the back-support section 16′ to be reclined. Usually, the straps 66′ are adjusted to hold the back-support section 16′ in close contact with the rear edge regions 24′ of the side panel sections when the cradle is being fitted and during inflation. Adjustment to allow the back-support section 16′ to be reclined will usually only be carried out after the cradle is fully inflated where this is desirable for the comfort of the patient and is safe to do so. Similar adjustment of the fasteners 30 is possible with the first embodiment to allow the back-support section 16 to be reclined.

It will be noted that in this second embodiment, the lower end of the back-support section 16′ has a more pronounced central recessed region 56′ and downwardly projecting shoulders 58′, whilst the recess 44′ along the rear edge of the seat section 14′ is less pronounced. The shapes of the recess 44, 44′, 56, 56′ in the seat and back-support sections in any of the embodiments disclosed herein can be varied to suit particular applications. Accordingly, the cradle 10′ in accordance with the second embodiment could have seat and back-support sections having recesses shaped like those of the first embodiment and vice versa. However, it should also be noted that the seat section and/or back-support section could be formed without a recess 44, 44′, 56, 56′.

As illustrated in FIGS. 5 to 7, a leg support attachment 70 can be used in conjunction with the cradle 10′. A number of flexible hoops 72 are spaced along the outside of the lower edge region 22′ of each of the side panel sections 18′ 20′. The hoops 72 are aligned and dimensioned to receive elongate side bars 74 which engage in the hoops along respective sides and project forwardly of the seat section. The side bars 74 are rigid and weight-bearing and may be round, tubular members made from any suitable but preferably light weight load-bearing material. Each side bar 74 could be made up of a number of sections which are releasably connected together. A sling or support 76 made of a flexible material has hoops 78 on either side which can be slid over the forward ends of the side bars 74. The sling 76 is arranged to locate under the lower legs/calf region of a person seated in the cradle so as to hold and support their legs projecting straight out in front. This may be necessary for patients who have had hip or knee joint replacements or where it is otherwise desirable that the patient's legs be supported. The leg support 70 also enables the cradle 10′ to be used to automatically sit a patient upright from a supine position during inflation, as will be described later. The number of hoops 72 along each side of the cradle can be varied and some drawings show two hoops 72 whilst others show three. It should also be noted that the hoops 72 could be provided on the sides of the seat section 14′. The side bars 74 may also project rearwardly beyond the cradle to provide additional stability. The cradle 10 in accordance with the first embodiment can be adapted to receive a leg support attachment 70 and it will be appreciated that other arrangements for attaching a lower leg support to the cradle could be adopted in any of the embodiments.

FIGS. 5 to 8 also show how grab handles 80 can be provided on the cradle at various locations. The handles can be grasped by a care giver to assist in maneuvering the inflated cradle 10′ with a patient on-board. Similar grab handles 80 can be provided on the cradle according to any of the embodiments described herein. Alternatively, the cradle may be provided with a removable outer cover. In such an embodiment, handles or other features to assist a carer in physically maneuvering the cradle can be provided on the cover. The cover will typically be a tight fit when the cradle is inflated.

A range of cradles 10, 10′ in different sizes can be provided. It is expected that for most applications the cradle 10, 10′ will be dimensioned to support an adult, including bariatric adults, although versions for children or smaller adults may also be useful. For use with very large bariatric patients, the two parts of the cradle may have to be so large that they become difficult to handle and manipulate around the patient. To overcome this problem, one or both of the seat section 14, 14′ and the back-support section 16, 16′ could be split into two or more parts that can be fastened together, say using releasable fastenings similar to the fasteners 30. For example, the seat section 14, 14′ and the back-support section 16, 16′ could each be made in two separately inflatable halves that are fastened together once placed in position about the patient. Each part would be provided with its own inlet valve 36 and outlet dump valve 38. Alternatively, the two parts may be fluidly interconnected by means of an external releasable fluid coupling so that they can be inflated through a single fluid inlet.

In addition, or alternatively, the cradle may have separable side panel sections 18, 20, 18′, 20′ which are releasably connectable to both the back-support section 16, 16′ and the seat section 14, 14′. A third embodiment of an inflatable cradle 10″ in accordance with the invention and which has separable back-support 16″, seat 14″, and side panel sections 18″, 20″ is shown in FIGS. 9 and 10. Each inflatable section 16″, 14″, 18″, 20″ is constructed in a similar manner to the corresponding section in the previous embodiments and is made from similar materials. The reader should refer to the description of the previous embodiments for details. However, rather than the side panel sections 18″, 20″ being integrally formed with either the back-support section or the seat section, each side panel section 18″, 20″ is a separate inflatable body which is releasably attachable to both the seat section 14″ and the back-support section 16″.

Each side panel section 18″, 20″ is releasably connectable to the seat section 14″ by means of a first set of releasable fasteners 30a and with the back-support section 16″ by means of a second set of releasable fasteners 30b. The releasable fasteners 30a in the first set are each operative between the lower side edge region 22″ of the side panel section and the respective side edge region 28″ of the seat section 14″, whilst the releasable fasteners 30b in the second set are each operative between the rear edge region 24″ of the side panel section and the respective side edge region 26″ of the back-support section 16″. There are three fasteners 30a, 30b in each of the first and second sets, though the number of releasable fasteners can be varied. Each fastener 30a, 30b comprises a conventional type buckle 64″ attached to an outer surface of the side panel section 18″, 20″ and a corresponding flexible strap 66″ attached to the respective side edge 26″, 28″ of the back-support section 16″ or seat section 14″. The strap 66″ is releasably and adjustably secured to the buckle 64″ in the usual manner. To this end, the strap 66″ has a number of holes spaced along its length into which a pin on the buckle can be inserted. Other types of buckle such as a cam buckle or a ladder buckle could be used. Indeed, other forms of releasable fastener could be used to attach the side panel sections such as the fasteners 30 described in relation to the previous embodiments.

All the sections 14″, 16″, 18″, 20″ are inflated via a single one-way inlet valve 36 located on the rear surface at the top of the back-support section 16″. The inlet valve 36 has a female coupling 36a fluidly connected with the interior of the back-support section by a flexible hose 36b. The female coupling 36a includes a non-return valve. The interior of each side panel section 18″, 20″ is fluidly connected to the interior of the back-support section 16″ by means of a first external fluid connector 85a and with the interior of the seat section 14″ by means of a second external fluid connector 85b. Each fluid connector includes a female coupling 86a having a non-return valve and a male coupling 86b which is releasably insertable into the female coupling 86a to create a flow path. The non-return valve prevents pressurised air flowing out of the respective body section through the female coupling 86a when the male coupling 86b is disconnected. Each female and male coupling 86a, 86b is fluidly connected to the interior of its respective section of the cradle by a flexible hose 87. It is preferred that in the second fluid connectors 85b, the female coupling is connected with the interior of the respective side panel section 16″, 18″. This enables the seat section 14″ to be separated from the side panel sections 16″, 28″ when the cradle is inflated without the side-panel sections 16″, 18″ and the back-support section 16″ deflating.

When the first and second fluid connectors 85a, 85b are coupled, a fluid path is created between all the sections of the cradle 10″ so that the cradle can be inflated by the compressor 90. As described below, the compressor has a fluid supply line 94 including a hose 122 with a male coupling which is insertable in the female coupling 36a of the inlet valve to allow air under pressure to be introduced into the cradle. Once inflated, the compressor can be disconnected by withdrawing the male coupling from the female coupling 36a, the non-return valve in the female coupling 36a retaining the pressurised air in the cradle. However, the compressor 90 may remain attached to the cradle in order to monitor and regulate the inflation pressure as described below. As noted above, the second fluid connectors 85b can be disconnected to enable the seat section 14″ to be deflated and/or removed from the remainder of the cradle whilst the side panel sections and the back-support section remain inflated. The seat section 14″ can be subsequently re-inflated by reconnecting the second fluid connectors 85b and topping up the fluid pressure through the inlet valve 36.

Whilst there is only one inlet valve 36 in the present embodiment, additional inlet valves could be provided. For example a further inlet valve could be provided on the seat section 14″. Each of the seat, back-support, and side panel sections 14″, 16″, 18″, 20″ is provided with a dump valve 38 to enable the various sections to be deflated quickly and easily.

External fluid connectors similar to the connectors 85a, 85b described above can be adopted in the inflatable cradle 10, 10′ according to either of the first two embodiments to fluidly interconnect some or all of the inflatable sections in those cradles and to allow inflation of the cradle as a whole from a single inlet. Also, a similar inlet valve arrangement to that used in the cradle 10″ according to the third embodiment can be adopted for the inlet valves 36 in either of the cradles 10, 10′ according to the first and second embodiment.

The cradle 10″ according to the third embodiment has a pair of safety restraints 88 which are releasably connectable between the forward edge regions 25″ of the side panel sections 16″, 18″ to securely hold a patient in the cradle when it is inflated. Each restraint 88 comprises a flexible strap 88a attached to a forward edge region 25″ of one of the side panel sections 20″ and a corresponding buckle 88b attached to the forward edge region 25″ of the other side panel section 18″. The straps 88a are releasably and adjustably secured across the front of the inflated cradle using the buckles 88b. The number and position of the restraints 88 can be varied. Similar restraints can be provided on the cradle 10, 10′ according to either of the previous embodiments.

Other arrangements for releasably securing a strap or similar restraint across the front of the cradle can be adopted. Other arrangements for holding a patient securely in the cradle can also be adopted, such as a harness or the like.

The cradle 10″ according to the third embodiment can be provided with a rigid leg support 70 similar to that described above in relation to the second embodiment 10′. To this end, hoops 72 of flexible material can be provided spaced apart along the side edge regions of the side panel sections 18″, 20″ or the seat section 14″. However, other means of releasably securing a leg support 70 can also be adopted.

Use of the patient cradle 10, 10′, 10″ in the embodiments introduced so far will now be described. At least the surfaces on the cradle 10, 10″, 10″ which the patient will come into contact with may be made from or covered with a material of relatively low frictional resistance. Such materials are sometimes referred to as high slip materials. The material could be provided in the form of separate sheets that are placed between the cradle 10, 10′, 10″ and the patient each time it is used or in the form of covers that are semi-permanently fitted over the various parts of the cradle. The covers may be removable to allow for replacement, repair and/or cleaning. Alternatively, a low friction material may be permanently applied to the relevant surfaces of the cradle. The low friction/high slip material may be polyester and/or nylon or any other suitable material such as are used in the manufacture of glide sheets for patient transfer. The low friction/high slip material may comprise a base material coated with silicon or some other low friction substance. It should be assumed in the following description of the use of the cradle that a high slip material is in position between the cradle and the patient. If this material is not present on the cradle parts themselves, then sheets of high slip material can be placed between the parts of the cradle and the patient during the following procedures.

FIGS. 11 to 17 illustrate somewhat schematically a sequence for positioning a patient in the cradle 10′ according to the second embodiment. Similar procedures modified accordingly can be adopted for the cradle 10, 10″ in accordance with the first and third embodiments. In this sequence, the patient 82 is initially in a supine position on a bed 84 and may have insufficient upper body strength to support themselves in a sitting position on the bed.

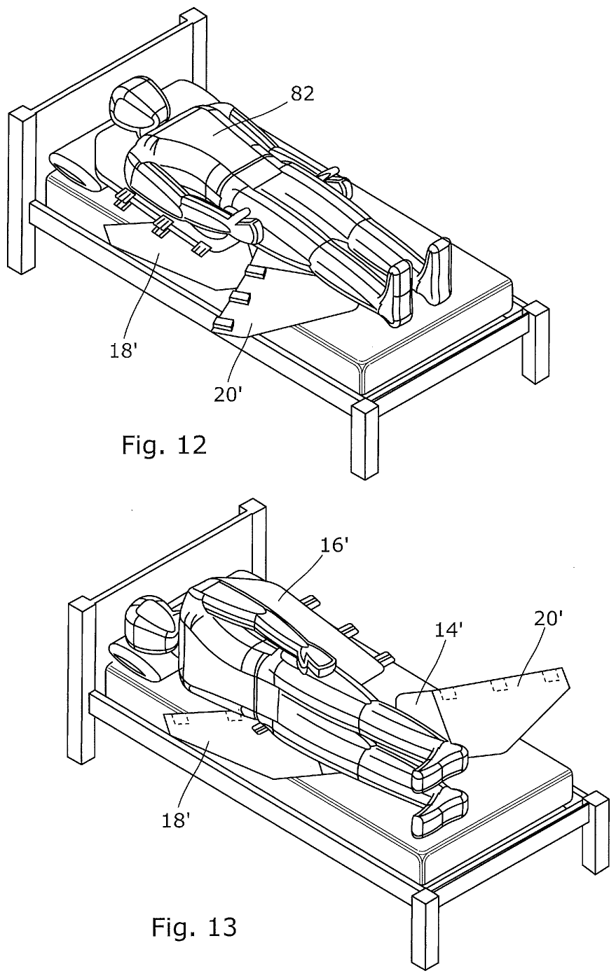

Starting with the patient 82 in a supine position on the bed 84, the two parts 32′, 34′ of the cradle 10′ are separate and in a fully deflated condition. The patient 82 is first rolled over to one side as shown in FIG. 11. The back-support portion 16′ is folded in half longitudinally and placed on the bed behind the patient's back and tucked in as close to the patient as possible. The second part 32′, including the seat section 14′ and the side panel sections 18′, 20′, is similarly folded in half and placed on the bed behind the patient's buttocks and thighs as close to them as possible. The patient 82 is gently rolled back into the supine position on top of the folded parts of the cradle and then onto their other side as shown in FIGS. 12 and 13. The folded half of the back-support section 16′ is teased through under the patient so that the back-support section is lying flat on the bed. Similarly, the folded half of the seat section 14′ and the attached side panel 20′ on that side are teased through under the patient until they lie flat on the bed. The patient is now rolled back into the supine position so that they are lying with their back on the un-inflated back-support section 16′ and at least their upper thighs on the seat section 14′. During the above procedures, the back-support section 16′ is pulled down the bed so that its lower end is as close to the patient's buttocks as possible and the seat section 14′ is pulled up the bed so that its rear edge is as close to the patient's buttocks and to the lower end of the back-support section as possible. The material at the lower end of the back-support section 16′ and the rear end of the seat section 14′ may be bunched up around the patient's buttocks/hips so that when these sections inflate, the material works its way further under the patient to assist in lifting them off the surface of the bed. This is made possible due to the flexible nature of the cradle when un-inflated and is assisted by the recessed regions 44′, 56′ at the rear edge of the seat section 14′ and the lower edge of the back-support section 16′, which allow the patient's buttocks to remain in contact with the bed. However, it is not essential that the rear edge of the seat section 14′ and the lower edge of the back-support section 16′ have recesses and the rear edge of the seat section and the lower edge of the back-support section be overlapped under the patient so that no part of them is in contact with the bed.

An advantage of the second embodiment of the cradle 10′ in which the side panel sections 18′, 20′ are attached to the seat section 14′ is that the side panel sections can be used to pull the seat section 14′ into position under the patient. However, it will be appreciated that the precise method for placing the seat section and the back-support section under the patient can be varied from those described above, which is only one of many possible methods.

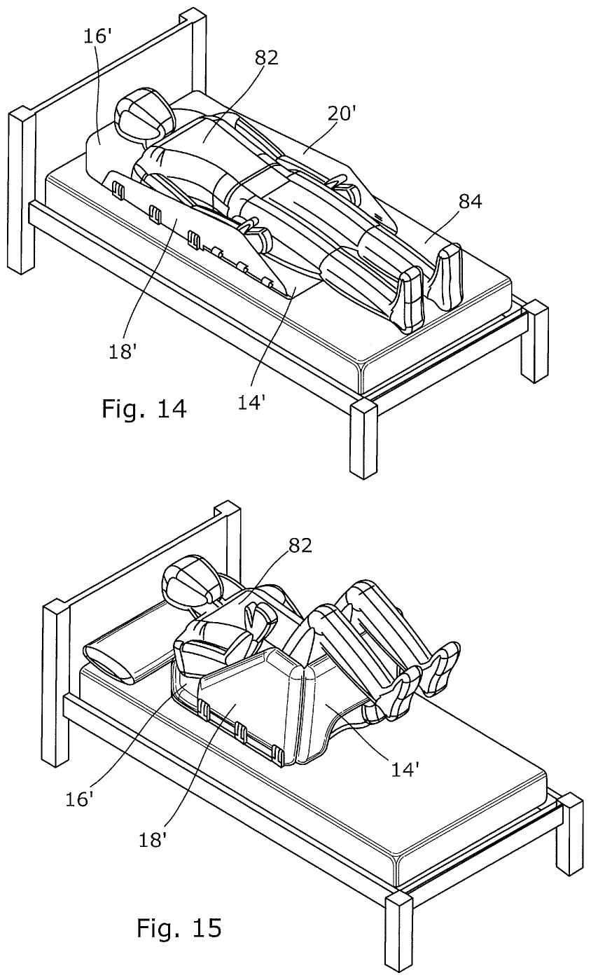

Once the back-support section 16′ and the seat section 14′ are in position, the side panel sections 18′, 20′ are manoeuvred up and around and the fasteners 30 engaged to attach each side panel section 18′, 20′ to its respective side of the back-support section 16′. The dimensions and the flexibility of the parts of the cradle allow the side panel sections 18′, 20′ to be attached to the back seat portion 16′ when the cradle is un-inflated whilst the patient remains in a supine position with their legs generally flat on the bed as shown, somewhat schematically, in FIG. 14. For example, the sides of the un-inflated back-support section are able to curve around the sides of the patient's torso whilst the sides of the un-inflated seat section are able to curve up around the sides of the patient's upper thigh/buttock region to enable the side panel sections to be attached whilst the patient's legs remain largely flat on the bed. However, the patient's thighs may be lifted off the bed to an extent as the side panels are connected, with the seat section slightly angled relative to the back-support section. The straps of the fasteners 30 at this stage are adjusted as short as possible so that the rear edges of the side panel sections 18′, 20′ are held close to the sides of the back-support section 16′.

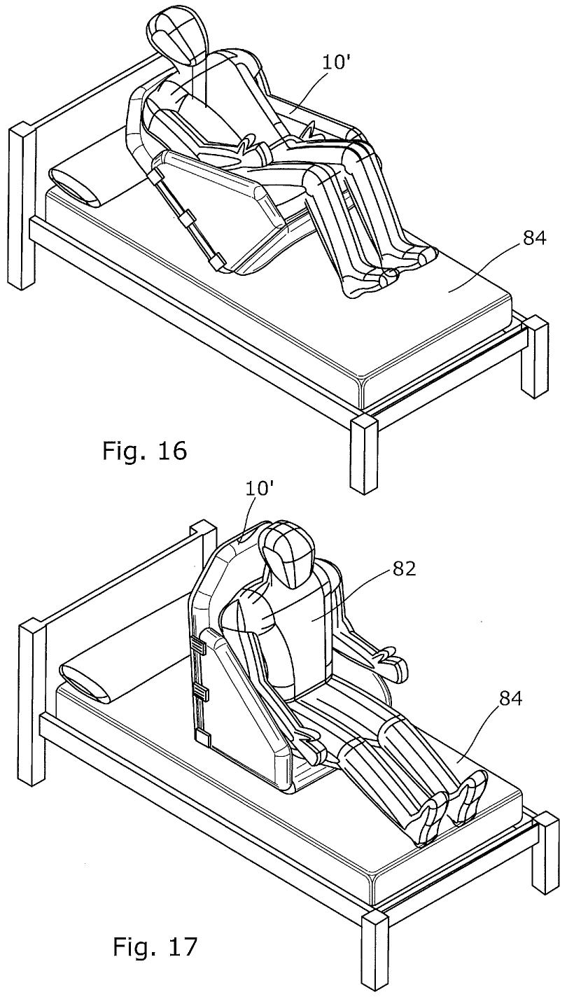

The cradle 10′ is now ready to be inflated using the air compressor 90 connected to the inlet valves 36 of both parts of the cradle so that they are inflated simultaneously. Compressed air is introduced into both parts 32′, 34′ but as a significant proportion of the weight of the patient is concentrated on the seat section 14′ and the back-support section 16′, the side panel sections 18′, 20′ will tend to inflate first. This has the effect of drawing the back-support section 16′ forwardly (down the bed) so that the patient's buttocks are moved onto the seat section 14′. If the lower edge of the back-support section 16′ is bunched or folded about the patient's buttocks it will tend to creep under their buttocks/lower back. As the inflatable sections become more rigid and straighten out, the seat section 14′ and back-support sections are moved to a position in which they extend generally perpendicular to one another to form a seat-like structure. In this embodiment, the weight of the patient holds the back-support member 16′ on the bed and the lower surface of the seat section is drawn off the bed such that the patient's upper legs are raised off the bed to place them in a “sitting position” but with the back-support section 16′ lying flat on the bed. This is illustrated in FIG. 15. As all the sections 14′, 16′, 18′, 20′ of the cradle become fully inflated, the seat section 14′ is drawn fully onto the patient's buttocks and held tight against the lower edge of the back-support section either side of the recess 56′. The patient is now supported in the cradle and the patient and cradle 10′ can be gently tilted forwardly to place them in an upright sitting position with the seat section 14′ on the upper surface of the bed mattress as shown in FIGS. 16 and 17.

It will be noted that at no time during the above-described procedures is it necessary for a care giver to manually lift the patient fully off the bed. It is only as the cradle 10′ inflates that the patient is raised off the bed surface. Where the seat section 14′ or back-support section have a recess, at least part of the patient's buttock region may remain in contact with the bed until the cradle is inflated.

In the method described above, the patient 82 remains on their back as the cradle is inflated. FIGS. 18 and 19 illustrate an alternative method using the lower leg support 70 in which the cradle is automatically raised to an upright sitting position as it inflates. In this alternative method, the lower leg support 70 is attached to the cradle 10′ after it has been placed about the patient and the two parts 32′, 34′ connected together but just prior to inflation. To attach the leg support 70, the side bars 74 are inserted into the hoops 72 on their respective sides and the sling 76 is attached to the forward ends of the side bars so that the sling is positioned beneath the patient's feet/lower calf region as illustrated in FIG. 18. At this stage, the patient remains generally in a supine position. The cradle is now inflated. As the cradle inflates, the weight of the patient's legs acting on the sling 76 of the leg support holds the seat section 14′ flat on the bed so that the back-support section 16′ and the side panel sections 18′, 20, are drawn up off the bed to an upright position as shown in FIG. 19. The carers can assist in tilting the cradle forward as it inflates. This pneumatically raises the patient into an upright sitting position automatically and ensures that the patient's legs remain largely horizontal to the support surface of the bed at all times. If necessary, additional weight could be added to the leg support 70. This might be required where the patient is a single or double amputee, for example, but may also be required in other circumstances. It will be appreciated that the seat section 14 could be held in contact with the bed by means other than a lower-leg support. For example, other arrangements to weigh down the seat section or of applying a force to it to hold it in contact with the bed can be adopted.

Once the cradle 10′ is fully inflated and in an upright position on the bed or other supporting surface, the patient is stably supported by the cradle in a suitable upright sitting position for transfer. It will be recognised that the above-described sequences can be reversed to position a patient in bed from an inflated cradle.

The cradle 10″ according to the third embodiment is placed about a patient and inflated in a similar manner to that described above but the main differences will now be described. Initially, the seat, back-support, and side panel sections 14″, 16″, 18″, 20″ are all separated from one another and in an un-inflated condition. With the patient lying in a supine position on a bed or other support, the seat section 14″ is positioned under their thigh/buttock region and the back-support section 16″ is positioned under their back making sure that the rear edge of seat section 14″ and lower edge of the back-support section 16″ are as close together as possible or overlapping. The patient can be manoeuvred and rolled in the usual way during this part of the procedure. The side panel sections 18″, 20″ are then attached between the seat section 14″ and the back-support section 16″, using the releasable fasteners 30a, 30b, and the fluid connectors 85a, 85b assembled. The side panel sections may be attached sequentially or at the same time depending on how many carers are present.

Once the side panel sections 18″, 20″ have been securely connected and the fluid connections established, the cradle is inflated by connecting the compressor 90 to the inlet valve 36. The cradle 10″ is inflated gradually so that the patient is moved into a sitting position safely and comfortably as the inflatable sections of the cradle inflate. If the cradle is used without a lower leg support 70, the patient will be placed in a sitting position but lying on their back and the cradle is then gently tipped forward to place the cradle and the patient in an upright sitting position with the seat section 14″ on the bed, as described above in relation to FIGS. 14 to 17. If the cradle 10″ is used with a leg support 70, then it will automatically tip forward gently as it is inflated, as described previously with regard to FIGS. 18 and 19. When the cradle is fully inflated the restraints 88 are secured in position. The patient is now ready to be maneuvered with the cradle.

The above-described methods of positioning the un-inflated cradle about a patient are particularly suitable for patients with limited upper body strength who cannot sit upright on a bed unaided. However, where a patient is able to sit upright on a bed or where there are sufficient carers to assist in holding the patient upright, the method can be adapted so that the un-inflated cradle, or at least part of it, is fitted with the patient in an upright sitting position on the bed. For example, the seat section could be positioned beneath the patient whilst they are lying on the bed and the patient then sat up whilst the back-support section is located about their back and the side panel sections connected.

The inflatable patient cradle 10, 10′, 10″ is a highly flexible piece of apparatus that can be used in many different ways to support a patient for transfer and for treatment or care. The above-described methods are only examples of a number of different methods that can be used to place a patient in the cradle. However, in general, it is expected that the cradle will be positioned about the patient un-inflated, the side panel sections connected between the seat section and the back-support section as required, and the cradle subsequently inflated to define the seat structure in which the patient is supported and raised off the surface on which they are located. There are, however, various different ways in which the un-inflated cradle can be positioned about the patient, depending on the circumstances. For example, whilst the above methods describe the sections of the cradle being separated before the un-inflated cradle is positioned about the patient, it is not always necessary for any or all the parts to be separated. When fitting an un-inflated cradle 10, 10′, 10″ about a patient lying on a bed with good access from both sides, it may be possible to position the patient on the un-inflated cradle without separating any of the parts or by only disconnecting one of the side panel sections from at least one of the seat section and the back-support section. However, the ability to separate the various parts of the cradle provides flexibility in the way the cradle can be fitted and removed. For example, when fitting or removing the cradle about a patient sitting in a chair, it may be necessary that the seat section 14 is separated from the back-support section so that these can be positioned about the patient or removed independently of one another. Furthermore, the ability to remove the side panel sections, or at least move them out of the way about hinges, makes it possible for a patient to be moved sideways on or off the seat section and back-support sections.

In addition to providing flexibility in the way the cradle is fitted and used, forming the cradle with at least two separable parts also allows parts of the cradle to be removed for cleaning or repair and for a part of one cradle to be used with a part from another similar cradle. It also enables a cradle to be provided with different, interchangeable seat sections adapted for different applications. In one example, a seat section 14, 14′, 14″ could be provided with a toileting aperture and a user could choose whether to use a standard seat section with no toileting aperture or a seat section with a toileting aperture in the cradle.

Whilst an inflatable cradle having at least two separable parts has certain advantages in terms of flexibility of use, an inflatable patient cradle formed in one piece can also be useful. FIGS. 20 and 21 illustrate two further embodiments of an inflatable cradle 10″, 10″″. These embodiments are similar to the embodiments 10 shown in FIGS. 1 to 4 and 10″ FIGS. 5 to 8 respectively, except that they are formed as a single integral member in which the seat section 14″, 14″ and the back-support section 16′″, 16″″ are interconnected by a flexible hinge portion 45, similar to hinge portions 42, 42′ as described above. There is no recess along the rear edge of the seat section or the lower edge of the back-support section but the seat section is provided with a toileting aperture 47. A cradle 10′″, 10″″ in accordance with these embodiments can be positioned about a patient lying or sitting on a surface, such as a bed, using methods similar to those described above. To assist in this, at least one side panel section 18′″, 20′″; 18″″, 20″″ may be disconnected from the seat section or back-support section as appropriate. Once in place under the patient, the side panel sections are re-attached as required and the cradle inflated. With a patient supported in the inflated cradle in an upright sitting position, the cradle can be moved to place the patient over a toilet or commode and the patient toileted. After toileting, the procedure can be reversed to return the patient to bed.

A toileting aperture 47 similar to that shown in FIGS. 20 and 21 can be adopted in the seat sections 14, 14′, 14″ of any of the embodiments of the cradle 10, 10′, 10″ previously described. Where a toileting aperture 47 is adopted, the seat section may not have a recess along its rear edge to ensure there is sufficient area to lift and support the patient. For use with a seat section having a toileting aperture 47, a replaceable protective membrane or cover may be placed between the patient and the seat section to reduce soiling of the seat section. The membrane may extend into the toileting aperture.

In order to stably hold a patient in an upright sitting position, the back-support section must extend to a suitable height, which will typically be at least up to shoulder height for the intended size of user but may also extend to head height and the back-support section could incorporate a head restraint portion 16a as illustrated in FIGS. 20 and 21. The side panel sections must extend sufficiently far up the back-support section that they hold the back-support section upright over its full height. Typically, the patient's arms are constrained within the side panel sections when the cradle is inflated. In addition to acting in tension to hold the back-support section upright, the side panel sections contact both the seat section and the back-support section to act in compression to prevent the back-support section being tipped forwardly beyond the vertical. This is helpful when a patient is being transferred in the cradle so that they are not inadvertently tipped forward out of the cradle. However, in an alternative embodiment, the side panel sections may not be inflatable but could be thin flexible members which act in tension when the cradle is inflated to hold the back-support section upright but which do not act in compression.

In order to stably support a patient in an upright sitting position and in order to be able to lift the patient dynamically as the cradle inflates, the cradle must be inflated to a suitably high pressure to provide the required lift and rigidity. The pressure required to lift a patient depends on their weight and the area of the inflatable section which is doing the lifting, which will either be the seat section or the back-support section. In use to lift a patient having a weight in the region of 95 kg to 127 kg, which is a typical weight range for adults in a care home or hospital, it has been found in one embodiment that the cradle would typically be inflated to a pressure of around 27 kPa to 34 kPa. However, a lower pressure could potentially be used if the surface area of the inflatable sections is increased, provided the inflatable cradle is sufficiently rigid to support the patient once inflated. The inflatable sections of the cradle should be constructed to be able to withstand the maximum pressure required for its intended use.

With a patient 82 supported in an upright sitting position in the inflated cradle 10, 10′, 10″, 10′″, 10″″, the cradle can be manoeuvred across a surface manually, perhaps with the assistance of a glide sheet or other low friction material placed between the seat section 14′ and the surface. The cradle 10, 10′, 10″, 10′″, 10″″ could also be provided with attachments to enable it to be lifted by means of a crane or hoist, with the patient safely on-board. A detachable strap could be provided to enable a carer to pull the cradle along.

Also a part of the patient handling apparatus in accordance with an aspect of the invention is the portable compressor 90 which is used to inflate the cradle and to regulate inflation pressure as illustrated in FIGS. 22 and 23. FIG. 22 illustrates schematically a compressor 90 attached to the cradle 10″ as described above with relation to FIG. 9 but the compressor 90 can be used with the cradle according to any of the embodiments disclosed herein.

In the present embodiment, the compressor comprises an electrically driven pump 92 to supply compressed air to the cradle via an air fluid supply line 94. The compressor has a control system 96, illustrated schematically in FIG. 23, which includes a microprocessor 98, a pressure sensor 100 for detecting the pressure of the air in the cradle, and an electronic controlled solenoid valve 102 which can be opened to vent air from cradle in use. The microprocessor 98 is operative to control operation of the compressor pump 92 through a motor controller 104 and the solenoid valve through a relay switch 106 in accordance with an algorithm and in response to inputs from the pressure sensor and a user via a user interface 108 of the compressor. The user interface 108 includes an on/off switch 110, a reduced or low pressure mode switch 112, and a hand held remote 114 which has inputs that can be used to control the inflation of the cradle. The remote control is advantageous as it means a carer can control the inflation whilst standing next to the patient and monitoring events. The control system and pump are powered from a battery 116.

The pump 92 and the majority of the control system 96 components are located in a housing 118 to form a compressor unit 120. The housing 118 may conveniently be provided with a carrying handle 119 for ease of portability but this is not essential. The pressure sensor 100 and the solenoid valve 102 may each be located within the compressor unit 120 or externally to the compressor unit 120. For the sensor 100, it is necessary that this is able to detect the inflation pressure in the cradle and can be located anywhere in or fluidly connected with the fluid supply line at a position where it is subject to the inflation pressure of the cradle in use. Similarly, the solenoid valve 102 can be located anywhere in or fluidly connected with the fluid supply line provided that it is operative to vent air from the cradle when opened in use.

The air fluid supply line 94 may include a flexible hose 122 having a connector (e.g. a male coupling) for releasable engagement with the inlet valve 36a of the cradle 10″ at one end. The hose 122 may also be releasably connectable to the compressor unit 120 by means of a releasable coupling to a conduit in the compressor unit fluidly connected with the outlet (pressure) side 124 of the pump 92. Such a coupling may include a female coupling member at an end of the conduit which can be accessed externally of the compressor unit and a corresponding male coupling member at the other end of the hose 122. The female coupling member includes a valve which closes the conduit in the compressor unit when the flexible pipe 122 is disconnected. The conduit and coupling member form part of the fluid supply line within the compressor unit 120.

In some embodiments, the compressor 90 is used to inflate and regulate the inflation pressure of all the inflatable sections of the cradle together as a single unit. In such embodiments, the compressor may have only one fluid supply line which is connected to the, or each, inlet valve 36 of the cradle. Only one pressure sensor 100 and one solenoid valve 102 are required. In other embodiments where the cradle has inflatable sections which can be inflated independently of each other, it may be desirable to be able to inflate and control the inflation pressure of at least some of the inflatable sections independently of each other. For example, it may be desirable to be able to inflate and regulate the inflation pressures of the seat and back-support sections independently of one another. To allow for this, the compressor 90 can be provided with more than one fluid supply line, each fluid supply line being connectable to at least one independently inflatable section of the cradle. Each fluid supply line has its own pressure sensor 100 and solenoid valve 102 so that the compressor can inflate and regulate the inflation pressure of the inflatable section or sections to which it is connected independently. Each fluid supply line is fluidly isolated from the others so that the pressure in each fluid supply line 94 is subject to the inflation pressure of the independently inflatable section or sections to which it is connected only. The control system is configured to monitor and regulate the air pressure in each of the fluid supply lines independently of one another.

Operation of the system will now be described with reference initially to inflation of a cradle 10″ which has a single inlet valve 36a and is inflated as a whole by the compressor 90 through a single fluid supply line 94 as illustrated in FIG. 22.

With the uninflated cradle 10″ in position about the patient ready for inflation, the fluid supply line 94 is connected to the inlet valve 36a and the compressor switched on. A carer initiates inflation of the cradle using the controls on the remote 114 which allow the carer to stop and start the pump 92 to introduce pressurised air into the cradle through the fluid supply line 94 in a controlled manner. As the cradle 10″ inflates, the control system monitors the pressure in the fluid supply line 94 using the pressure sensor 100 until the pressure in the fluid supply line/cradle reaches a first pre-defined value at which the cradle is fully inflated for transfer and the pump is automatically switched off. This prevents overinflation of the cradle. If the compressor remains attached to the cradle, the control system continues to monitor the pressure in the fluid supply line 94 and should the inflation pressure fall by a set limit, the control system reactivates the pump to top-up the air in the cradle and bring the inflation pressure back up to the first pre-defined value, Should the inflation pressure exceed the first pre-defined value by a further set limit, the control system opens the solenoid valve 102 to vent air from the fluid supply line and cradle to bring the inflation pressure down to the first pre-defined value. Thus the compressor 90 maintains the cradle at the first pre-defined inflation pressure within the limits set. However, when the cradle is to be moved, the fluid supply line hose 122 can be disconnected from the inlet valve 36a of the cradle to provide greater freedom of movement.

As discussed above, the cradle is inflated to a relatively high pressure, typically at least 27 kPa for use in transferring a patient. At this level of inflation pressure, the cradle forms a very rigid, self-supporting structure in which a patient is safely held and supported in a sitting position and which can be easily handled by carers. For many situations, it is expected that the cradle would be used to move a patient and then removed so that the patient will only be in the cradle for a limited time whilst being actively transferred. Nevertheless, in certain circumstances it may be necessary or desirable for a patient to spend an extended period in the inflated cradle whilst the cradle is stationary. For example, if a patient is transferred from a bed to a chair, it may be desirable for the patient to remain seated in the cradle for a period of time whilst the cradle is supported on the chair rather than removing the cradle. However, due to its rigidity when fully inflated at the first pre-defined transfer inflation pressure, the cradle may be uncomfortable to sit in for an extended period of time. To overcome this issue, the inflation pressure of the cradle 10″ can be reduced from that used during transfer to provide a more comfortable seating surface. In practice, it has been found that reducing the inflation pressure by around 14 kPa from the transfer pressure provides a more comfortable surface for extended use. However, the amount of reduction will vary depending on the initial transfer inflation pressure and the need for the cradle to continue to hold the patient upright as well as the size and weight of the patient. The reduction in inflation pressure could be in the region of 6 kPa to 20 kPa, for example. The reduction in pressure is sufficient to reduce the firmness of the seating surface but without substantially changing the shape of the cradle or reducing its ability to hold and support a patient in an upright sitting position.

In order to provide for an automated facility to reduce the inflation pressure of the cradle when desired, the compressor 90 has a reduced pressure mode which can be selected using the reduced pressure mode switch 112. If a patient having been moved in the fully inflated cradle is to remain sitting in the cradle for an extended period, the compressor 90 air fluid supply line is reconnected to the cradle and the reduced pressure mode selected. When the reduced pressure mode is selected, the control system brings the inflation pressure of the cradle down to a second pre-defined value, which is lower than the first pre-defined value by opening the solenoid valve 102 to vent air from the fluid supply line/cradle. Once the inflation pressure reaches the second pre-defined value, the solenoid valve is closed. If the compressor 90 remains attached to the cradle, the control system continues to monitor the inflation pressure in the fluid supply line/cradle and should this fall below the second pre-defined value by a set limit the pump is reactivated until the inflation pressure is brought back up to the second pre-defined value. Should the inflation pressure exceed the second pre-defined value by a further set limit whilst the reduced pressure mode is selected, the control system opens the solenoid valve 102 to vent air from the fluid supply line and cradle to bring the inflation pressure down to the second pre-defined value. Thus, the compressor 90 maintains the cradle at the second pre-defined inflation pressure within the limits set whilst the reduced pressure mode is selected.

The second pre-defined inflation pressure can be set at an appropriate value taking into account the comfort of the patient and the need to adequately support them. Typically, it is expected that the second pre-defined inflation pressure will be in the region of 7 kPa to 21 kPa but values outside of this range are possible. The control system for the compressor may be provided with an input means that enables a user to set either of the first and second pre-defined inflation pressures or they may be pre-programmed.

Where the cradle has two or more independently inflatable sections, such as the cradle 10 of the first described embodiment, a compressor 90 having more than one fluid supply line as discussed above can be used to inflate and regulate the inflation pressure of two or more of the independently inflatable sections independently of one another. For example, one fluid supply line 94 can be connected to an independently inflatable seat section 14 and another fluid supply line 94 to the back-support section and side panel sections. With this arrangement, the control system could be configured so that only the inflation pressure of the seat section is lowered to the second pre-defined value when the reduced pressure mode is selected. This may be beneficial in providing a more comfortable seating surface whilst the back-support and side panel sections are maintained rigid in order to support the patient's torso. Alternatively, the inflation pressure in the seat section and the back-support/side panel sections can both be lowered in the reduced pressure mode but by differing amounts to different pre-defined second pressures. This provides flexibility in determining the level of support and comfort provided by the cradle. In this embodiment, the control system could also be configured to maintain the independently inflatable sections of the cradle at different first pre-defined pressures in the high pressure/transfer mode. Further, the control system may be configured to alternately vary the inflation pressure of the cradle within limits when in the reduced pressure mode. Thus, rather than maintain the inflation pressure at a fixed second pre-defined value, the inflation pressure may be alternately varied within a given range. This helps to reduce the risk of pressure sores developing. The amount of variation in the inflation pressure is selected to ensure patient support and comfort and the variation could be in the range of 2 kPa to 15 kPa, or 2 kPa to 5 kPa for example. In this regard, the highest pressure in the range is always lower than the first-predefined pressure used when a patient is being transferred and can be regarded as the second pre-defined pressure or the second pre-defined pressure can be considered as a range of pressures, all lower than the first-predefined pressure but higher than zero.

In a further alternative embodiment, at least the seat section 14 of the cradle can be provided with first and second sets of inflatable cells, the cells in the first and second sets being alternately located or intermixed and the system configured so that when the compressor 90 is in the reduced pressure mode, the first and second cells are alternately inflated/deflated between set limits. For example, each set of cells may be alternately deflated below the second pre-defined pressure by a set amount to a third pre-defined inflation pressure and then re-inflated back up to the second pre-defined pressure. This can be advantageous in constantly adjusting the points of contact between the patient and the seat section and so reducing the risk of pressure sores developing. The amount by which the cells are deflated is selected to achieve the desired variation in contact points whilst also ensuring adequate support for the patient. The reduction in pressure could, for example, be in the range of 2 kPa to 15 kPa, or in the range of 2 kPa to 10 kPa, or in the range of 4 kPa to 8 kPa. A similar alternately inflatable cell arrangement can be adopted in the back-support section and/or the side panels. It is expected that in the high pressure transfer mode, both sets of cells will be inflated to the first pre-defined pressure simultaneously.

FIG. 24 illustrates schematically an example of a basic fluid circuit that can be adopted in the patient handling system to alternately inflate/deflate a first set 130 and second set 132 of inflatable cells.

The circuit includes a first fluid supply line 94a fluidly connected with the inflatable cells in the first set 130 and a second fluid supply line 94b fluidly connected with the inflatable cells in the second set 132. A first solenoid on/off valve 134a is provided in the first flow path to control the flow of air and a first pressure sensor 100a is fluidly connected with the first supply line 94a between the first valve 134a and the first set of inflatable cells 130. Similarly, a second solenoid on/off valve 134b is provided in the second flow path 94b to control the flow of air and a second pressure sensor 100b is fluidly connected with the second supply line 94b between the second valve 134b and the second set of inflatable cells 132.

The two supply lines 94a, 94b are alternately connectable with the outlet 124 of the compressor pump 92 or with a vent 136 by a third solenoid valve 102. A one way valve 138 is located in the flow path between the pump 92 and the third solenoid valve 102 to prevent air flowing back through the pump.

An exemplary method of using the circuit in FIG. 24 to alternately deflate and re-inflate the first and second sets of cells will now be described. For the purposes of this description, the following designations will be used:
P1—the first pre-defined pressure (high transfer pressure);
P2—the second pre-defined pressure (reduced pressure for comfort);
P3—the third pre-defined pressure (pressure to which cells are deflated below the second-pre-defined pressure)

During use of the system to transfer a patient, the first and second valves 134a, 134b are both set to the open position as shown. In this configuration, the control system 96 is able to regulate the inflation and deflation of the two sets of cells 130, 132 simultaneously using the third solenoid valve 102 to connect the both supply lines 94a, 94b simultaneously to the pump 92 or the vent 136 as required. The control system 96 may take an average reading from the two pressure sensors 100a, 100b or may only use one of the sensors to monitor the pressure. If the reduced pressure mode is selected, the control system 96 may be configured to reduce the pressure in both sets of cells 130, 132 to the second pre-defined value P2 initially.

Once in the reduced pressure mode, an alternating inflation/deflation mode can be selected by an appropriate input of the user interface 108 or an alternating inflation/deflation mode may be automatically implemented when entering the reduced pressure mode. When in the alternating inflation/deflation mode, the control system 96 uses the various solenoid valves 134a, 134b, 102 and the pump to alternately partially deflate and re-inflate the two sets of cells in a continuous or discontinuous cycle. This will now be described, starting with a situation in which both sets of cells 130, 132 are at P2.

To partially deflate the first set of cells 130, the control system 96 closes the second solenoid valve 134b, isolating the second set of cells 132 from the third valve 102 (and hence the pump 92 and the vent 136) whilst the first valve 134a is open. The control system 96 switches the third solenoid valve 102 to connect the first supply line 94a with the vent 136 to vent air from the first set of cells 130 and monitors the pressure in the first set of cells 130 using the first pressure sensor 100a. Once the pressure in the first set of cells 130 falls to P3, the third solenoid valve 102 is switched to reconnect the first fluid supply line 94a with the pump 92 and isolate it from the vent 136. The control system 96 then activates the pump 92 to re-inflate the first set of cells back up to P2. There may be a delay before the pump is actuated to re-inflate the cells 130. When the first set of cells 130 are re-inflated to P2, the control system 96 stops the pump and closes the first solenoid valve 134a to isolate the first supply line 94a and first set of cells 130 from the third valve 102. This completes a first half cycle. The control system can then switch to complete the other half cycle by opening the valve 134b and using the third valve 102 and the pump 92 to deflate and re-inflate the second set of cells in a similar way. There may be a delay between one set of cells being re-inflated and the next being deflated. This cycle can be repeated continuously or periodically.

In the above described method, one set of cells 130, 132 is maintained at P2 whilst the other is deflated to P3 and then re-inflated. In a variation of this method, at the start of each half cycle the first and second valves 134a, 134b can both be opened whilst the third valve 102 is connected to the pump (i.e. isolated from the vent) to interconnect the first and second sets of cells 130, 132 until the pressure in the two sets of cells is equalised at a pressure below P2 but above P3. The control system can then proceed to fully deflate the set of the cells which were at P2 at the start of the half cycle and re-inflate the other set. This halves the pressure range over which the pump 92 must work.

FIG. 25 illustrates how the circuit in FIG. 24 can be modified to incorporate an accumulator 138 in which pressurised air vented from the cells 130, 132 is stored and subsequently used to help re-inflate the cells 130, 132. This reduces the runtime of the pump 92 and so improves efficiency.

The accumulator 138 is fluidly connected with each of the first and second supply lines 94a, 94b at a point between the respective on/off valve 134a, 134b and the cells 130, 132 by respective fluid paths 140a, 140b. A fourth solenoid on/off valve 142a is located in the fluid path 140a between the accumulator 138 and the first supply line 94a and a fifth solenoid on/off valve 142b is located in the fluid path 140b between the accumulator 138 and the second supply line 94b.

One exemplary method of alternately inflating and deflating the first and second sets of cells using the circuit shown in FIG. 25 will now be described.

With both sets of cells 130, 132 at P2, the control system partially deflates the first set of cells 130 by closing the first, second and fifth valves 134a, 134b. 142b and opening the fourth solenoid valve 142a. This enables pressurised air to vent from the first set of cells 130 into the accumulator 138, which initially is at a lower pressure than the cells 130. When the pressure in the first set of cells 130 and the accumulator 138 have equalised, the control system closes the fourth valve 142a and opens the first valve 134a to connect the first supply line 94a to the third valve 102. The third valve 102 is switched to connect the first supply line 94a to the vent 136 to vent further air from the first set of cells 130. The control system 96 continues to monitor the pressure in the first set of cells/first supply line using the first pressure sensor 100a until it reaches P3, at which point the control system switches the third valve 102 to reconnect the first supply line 94a to the pump 92 and isolate it from the vent 136.

At this stage, the air pressure P3 in the first set of cells 130 is lower than that in the accumulator 138. To re-inflate the first set of cells 130, the control system 96 initially opens the fourth valve 142a to fluidly connect the accumulator 138 to the first supply line 94a. The first valve 134a can also be closed. Pressurised air flows from the accumulator into the first supply line 94a and partially re-inflates the first set of cells 130. When the pressure in the accumulator 138 and the first supply line/first set of cells has equalised, the control system closes the fourth valve 142a and, with the first valve 134a open, activates the pump 92 to continue re-inflating the first set of cells 130 back up to P2. Once the first set of cells 130 is re-inflated, the control 96 system stops the pump and can then switch to partially deflate the second set of cells 132 by closing the first, second and fourth valves 134a, 134b, 142a and opening the fifth valve 142b to vent air from the second set of cells 132 into the accumulator. The control system then regulates the continued partial deflation and subsequent re-inflation of the second set of cells 132 using the second, third and fifth valves 134b, 102, 142b and the pump 92 in a similar manner to that described above for the first set of cells 130. As with the previous embodiment, the process of alternate partial deflation and re-inflation of the two sets of cells 132, 133 can be carried out continuously or periodically.

Use of an accumulator 138 as described reduces the amount of time the pump 92 needs to operate and so improves efficiency. The above method can be varied to further reduce the amount of time the pump 92 is run. For example, when deflating the cells from the high transfer pressure P3 to the reduced pressure P2, both sets of cells 130, 132 can be connected initially with the accumulator to store pressurised air in the accumulator for later use in re-inflating the cells. Furthermore, in the above described method, one set of cells is always maintained at the second pre-defined pressure P2 whilst the other set is deflated and re-inflated. In a variation, the two sets of cells 130, 132 can be interconnected during the alternating cycle so that air from the set of cells which is being deflated can be used to partially re-inflate the other set of cells.

An example of this alternative method will be described briefly, starting with the situation where the first set of cells 130 are at P2, the second set of cells 132 are at P3 and the accumulator 138 is at a low pressure.

The first set of cells 130 are connected to the accumulator 138 by opening the fourth valve 142a with the first, second, and fifth valves 134a, 134b, 142b closed so that air vents from the cells 130 into the accumulator 138.

The first and second sets of cells 130, 132 are then interconnected by opening the first and second valves 134a, 134b with the third and fourth valves 142a, 142b closed. This equalises the pressure in the two sets of cells 130, 132 at a pressure below P2, further deflating the first set of cells 130 and partially re-inflating the second set of cells.

The second set of cells 132 is then connected to the accumulator 138 by opening the fifth valve 142b with first, second, and third valves 134a, 134b, 142a closed to further re-inflate the second set of cells 132.

The first set of cells 130 are vented down to P3 by opening the first valve 134a, with the second, fourth and fifth valves 134b, 142a, closed and switching the third valve 102 to connect the first supply line 94a to the vent 136. When the first set of cells 130 reaches P3, the third valve 102 is switched to isolate the first supply line 94a from the vent 136.

The second set of cells 132 are pumped up to the second pre-defined pressure P2 by opening the second valve 134b with the first, fourth, and fifth valves 134a, 142a, 142b closed and operating the pump.

When the second set of cells reaches P2, the pump 92 is stopped and the first half cycle is complete. The above method can then be repeated, mutatis mutandis, to achieve the opposite air movement deflating the second set of cells 132 and re-inflating the first set of cells 130.

It will be appreciated that the circuits described are exemplary only and that many variations are possible. For example, at least some of the valves could be incorporated into a single valve unit. Furthermore, more than one accumulator could be used to further increase efficiency. There could also be more than two sets of inflatable cells.

The various valves 134a, 134b, 102, 142a, 142b and the pressure sensors 100a, 100b may be incorporated within the compressor unit.

Where the terms “comprise”, “comprises”, “comprised” or “comprising” are used in this specification, they are to be interpreted as specifying the presence of the stated features, integers, steps or components referred to, but not to preclude the presence or addition of one or more other feature, integer, step, component or group thereof.

The above embodiments are described by way of example only. Many variations are possible without departing from the scope of the invention.

1. A patient handling apparatus comprising an inflatable patient cradle for holding and supporting a patient in a sitting position when inflated, and an air compressor connectable to the cradle to inflate the cradle, the air compressor having a control system for regulating the pressure of inflation of the cradle in use, wherein the control system is operative in a high pressure mode to bring the cradle to a first pre-defined inflation pressure and operable in a reduced pressure mode to bring at least part of the cradle to a second pre-defined inflation pressure lower than the first pre-defined inflation pressure.

2. A patient handling apparatus as claimed in claim 1, wherein the control system includes a pressure sensing arrangement for determining the pressure of air in the cradle and a user interface for selectively placing the compressor in the high pressure mode or the reduced pressure mode of operation.

3. A patient handling arrangement as claimed in claim 1, in which the inflated cradle is capable of holding and supporting a patient in a sitting position when inflated to each of the first and the second pre-defined inflation pressures.

4. A patient handling apparatus as claimed in claim 1, wherein the cradle comprises a plurality of inflatable sections, each inflatable section comprising a soft-walled inflatable body which is flexible when un-inflated.

5. A patient handling apparatus as claimed in claim 4, wherein all the inflatable sections are fluidly interconnected when the cradle is assembled so as to be inflatable simultaneously by the compressor, the compressor being operative in use to regulate the pressure in the cradle as a whole.

6. A patient handling apparatus as claimed in claim 4, wherein at least some of the inflatable sections of the cradle are inflatable independently of each other, the air compressor being operative in use to regulate the pressure in at least some independently inflatable sections independently of one another.

7. A patient handling system as claimed in claim 1, wherein the air compressor is operative in use to introduce pressurised air into the cradle and to allow air out of the air cradle to regulate the inflation pressure under control of the control system.

8. A patient handling system as claimed in claim 1, wherein the air compressor is operative in use when connected to the cradle to monitor the inflation pressure of the cradle and to maintain the inflation pressure substantially at the respective pre-defined pressure within limits.

9. A patient handling apparatus as claimed in claim 1, wherein the compressor has a pump having an outlet fluidly connectable with the cradle via at least one fluid supply line, the control system including a pressure sensor for sensing the pressure of air in the fluid supply line and a solenoid dump valve fluidly connected with the fluid supply line and openable to allow air to vent from the fluid supply line, the control system further including a microprocessor operative to regulate the inflation pressure of the cradle by controlling the operation of the pump and the solenoid valve in dependence on a signal from the pressure sensor.

10. A patient handling system as claimed in claim 9, wherein the cradle comprises a plurality of inflatable sections, each inflatable section comprising a soft-walled inflatable body which is flexible when un-inflated and wherein at least some of the inflatable sections of the cradle are inflatable independently of each other, the air compressor being operative in use to regulate the pressure in at least some independently inflatable sections independently of one another, the compressor having at least two fluid supply lines, the control system having a respective pressure sensor and a solenoid dump valve associated with each fluid supply line, the microprocessor being configured to regulate the inflation pressure of sections of the cradle connected with each fluid supply line independently of one another.

11. A patient handling system as claimed in claim 1, wherein the first pre-defined inflation pressure is at least 27 kPa.

12. A patient handling system as claimed in claim 1, wherein the second pre-defined inflation pressure is in the range of 6 kPa to 20 kPa lower than the first pre-defined inflation pressure.

13. A patient handling system as claimed in claim 1, wherein the second pre-defined inflation pressure is in the range of 7 kPa to 21 kPa.

14. A patient handling system as claimed in claim 1, wherein the control system is operative in the reduced pressure mode to alternately vary the inflation pressure of said at least a part of the cradle within set limits.

15. A patient handling system as claimed in claim 1, wherein at least the inflatable seat section of the cradle comprises a first set of inflatable cells and a second set of inflatable cells, the system configured such that in use when the compressor is in the reduced pressure mode it is selectively operable to alternately inflate and deflate the first and second sets of cells.

16. A patient handling system as claimed in claim 15, wherein the fluid circuit includes at least one fluid accumulator in fluid connection at least one set of cells for storing pressurised air released from said at least one set of cells when they are deflated for use in re-inflating at least one set of cells.

17. A method of handling a patient using apparatus as in claim 1, the method comprising: with the patient supported in the cradle inflated to the first pre-defined pressure and the compressor connected to the cradle, using the compressor to reduce the pressure of at least part of the cradle to the second pre-defined pressure by placing the compressor in the reduced pressure mode.

18. A method as claimed in claim 17, the method comprising using the compressor to maintain the inflation pressure of said at least a part of the cradle at the second pre-defined pressure within pre-set limits.

19. A method as claimed in claim 17, wherein at least the inflatable seat section of the cradle comprises a first set of inflatable cells and a second set of inflatable cells and the method comprises using the compressor to alternately inflate and deflate the first and second sets of cells.

20. A method as claimed in claim 19, the method comprising storing at least some of the pressurised air released from a set of cells when they are deflated in at least one accumulator and subsequently using the pressurised air stored in the at least one accumulator to at least partially inflate a set of cells.
